(19) United States
(12) Patent Application Publication
(10) Pub. No.: US 2012/0169104 A1
(43) Pub. Date: Jul. 5, 2012

(54) FITTING FOR A VEHICLE SEAT

(76) Inventors: Martin Stilleke, Recklinghausen (DE); Ulrich Lehmann, Alfter (DE); Heinz Voss, Leverkusen (DE); Michael Borbe, Rheinbach (DE)

(21) Appl. No.: 13/395,304

(22) PCT Filed: Aug. 20, 2010
(86) PCT No.: PCT/EP2010/005102

§ 371 Date: Mar. 9, 2012

(30) Foreign Application Priority Data
Sep. 10, 2009 (DE) 10 2009 041 490.8

(51) Int. Cl. B60N 2/225; B60N 2/235

(52) U.S. Cl. 297/362; 297/367 P

(57) ABSTRACT

A fitting (10) for a vehicle seat, in particular for a motor vehicle seat, has a first fitting part (11) and a second fitting part (12) which are rotatable relative to each other and which are axially held together by an enclosing ring (13). The enclosing ring (13) is provided with an inner ring section (13a), by which the enclosing ring (13) engages over the second fitting part (12) radially outward, and with an outer ring section (13b), by which the enclosing ring (13) is fixed to the first fitting part (11), at its front end, in an outer end section, and with a centering section (13c) which extends axially with respect to the outer ring section (13b). The centering section (13c) engages over the first fitting part (11) radially outward and partly covers the outer surface thereof.

### CROSS REFERENCE TO RELATED APPLICATIONS

This application is a United States National Phase application of International Application PCT/EP2010/005102 and claims the benefit of priority under 35 U.S.C. §119 of German Patent Application DE 10 2009 041 490.8 filed Sep. 10, 2009, the entire contents of which are incorporated herein by reference.

### FIELD OF THE INVENTION

The invention relates to a fitting for a vehicle seat, in particular for a motor vehicle seat, having a first fitting part and a second fitting part which are rotatable relative to each other and which are axially held together by an enclosing ring which is provided with an inner ring section, by means of which the enclosing ring engages over the second fitting part radially outward, and with an outer ring section by means of which the enclosing ring is fixed to the first fitting part, at its front end, in an outer end section.

### BACKGROUND OF THE INVENTION

A fitting of this type is known from DE 10 2005 029 449 B4. The enclosing ring which engages over the one fitting part with one inner ring section bears against the inner surface of the other fitting part with one adjacent outer ring section, without covering the outer surface of such other fitting part, and is welded thereto. In its interior, the fitting can be configured as a detent fitting or as a gear fitting. In practice, the fitting still leaves much to be desired.

### SUMMARY OF THE INVENTION

An object of the invention is to improve a fitting of the type mentioned in the introduction.

This object is achieved according to the invention by a fitting for a vehicle seat, in particular for a motor vehicle seat, having a first fitting part and a second fitting part which are rotatable relative to each other. The fitting parts are axially held together by an enclosing ring which is provided with an inner ring section, by means of which the enclosing ring engages over the second fitting part radially outward, and with an outer ring section, by means of which the enclosing ring is fixed to the first fitting part, at its front end, in an outer end section. The enclosing ring has a centering section which extends axially with respect to the outer ring section and which engages over the first fitting part radially outward and partly covers the outer surface thereof.

The fact that the enclosing ring has a centering section which extends axially with respect to the outer ring section and which engages over the first fitting part radially outward and partly covers its outer surface, creates a centering aid, which makes an exact positioning of the enclosing ring on the first fitting part possible, so that subsequently a faultless fixing of the enclosing ring at the first fitting part can take place. This avoids the problem which exists with the known fitting, namely that the enclosing ring is positioned faultily and subsequently welded in this faulty position, or that additional auxiliary devices, for example precisely worked stop jaws become necessary, in order to minimize rejects. In particular a closed, uninterrupted centering section protects the enclosing ring from being damaged between being manufactured and being built in. The enclosing ring which is fixed to the first fitting part besides increases solidity of the fitting and consequently its safety.

By providing a star shoulder as a shoulder which is provided as an axially protruding contour for the form-fitting cooperation with the structure of a seat part or of a backrest, this star shoulder having a multi-arm, substantially symmetric star shape, a defined interface between the fitting and the structure of the seat part or of the backrest is created. The interface is universally applicable in the different joining methods, for example for laser-welding with long, if appropriate, interrupted weld seams, and for MAG welding with single, short weld seams. For forming the star shoulder—compared to one single ring shoulder—only part of the material of the fitting part must be pressed out. Nevertheless, due to the shape of the star shoulder, the spacings which arise between the fixing points are relatively large. Compared to a plurality of single, cone-shaped shoulders, welding expenses on this end face of the fitting are reduced with one single star shoulder, since the welding process does not have to be interrupted several times. In a modified embodiment, only ring shoulders are provided.

If required, a certain orientation of the fitting part can be forced by means of the star shoulder. For this purpose, the exact symmetry of the star shape (rotational symmetry, mirror symmetry) can be broken also by a deviation, which, in its dimensions, is small with respect to the star shape, and which serves as an (additional) positioning aid or as an anti-rotation element. The star shoulder is particularly advantageous for detent fittings having a fourfold symmetry as well.

The solution according to the invention is at first independent from the inner structure of the fitting, i.e. whether it is designed as a gear fitting or as a detent fitting. A modular system, in which the same technique of the enclosing ring or the same defined interface to the structure is available, is thus possible, that is to say, the same installation space is required in general, and the same dimensions in particular, but the inner structure with respect to the special application can be substantiated, for example according to customers' requests.

The technique of the enclosing ring which has been developed further according to the invention leads to savings in weight and costs if, in the case of the gear fitting, the toothed wheel and, in the case of the detent fitting, the guide segments are configured at the radially outer edge of the assigned second fitting part. The enclosing ring can clasp over and cover the toothed wheel or over the guide segments, thus protecting them.

The use of an eccentric epicyclic gear system enables the inclination of the backrest of a vehicle seat to be adjusted continuously. The provision of a central pinion compared with a planetary gear system leads to the occurrence of a wobbling movement which is superimposed on the relative rotation of the fitting parts. The eccentric epicyclic gear system can be driven manually or by motor. The eccentric can be a fixed eccentric configured in one piece or an eccentric configured of several parts, consisting of wedge segments which are pre-biased towards one another and which keeps the fitting free of backlash.

The invention is explained in more detail hereinafter with reference to two exemplary embodiments with modifications shown in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an exploded view of the first exemplary embodiment;

FIG. 2 is an axial sectional view through the first exemplary embodiment;

FIG. 3 is a schematic view of a vehicle seat;

FIG. 4 is an axial sectional view through the second exemplary embodiment;

FIG. 5 is a radial sectional view through the second exemplary embodiment along the line V-V in FIG. 4;

FIG. 6 is a perspective view of the front end facing the seat part in the second exemplary embodiment;

FIG. 7 is a perspective view of the front end facing the backrest in the second exemplary embodiment;

FIG. 8 is a perspective view of the front end facing the seat part in the first exemplary embodiment;

FIG. 9 is a perspective view of front end facing the backrest in the first exemplary embodiment;

FIG. 10 is a side view of an adapter which is fixed with respect to the seat part;

FIG. 11 is a perspective partial view of a backrest side support;

FIG. 12 is a sectional view through an I-seam at a butt joint;

FIG. 13 is a sectional view through an I-seam at lap joint;

FIG. 14 is a sectional view in the area of an embossed centering section;

FIG. 15 is a sectional view in the area of a centering section due to bending of the edge;

FIG. 16 is a side view of an enclosing ring with a closed, uninterrupted centering section;

FIG. 17 is a side view of an enclosing ring with centering section in two arc pieces;

FIG. 18 is a side view of an enclosing ring with centering section in three arc pieces;

FIG. 19 is a side view of a modified enclosing ring;

FIG. 20 is a sectional view along the line XX-XX in FIG. 19;

FIG. 21 is a perspective view of a modification of the fitting with an adapter which is fixed with respect to the seat part; and

FIG. 22 is an exploded perspective view of the adapter which is fixed with respect to the seat part, of the second fitting part and of two alternative enclosing rings of the modification in FIG. 21.

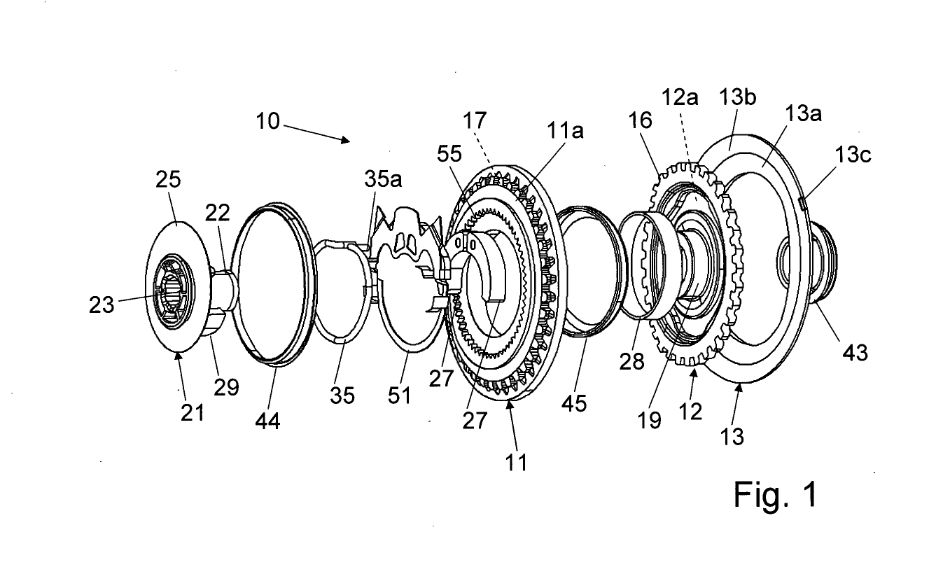

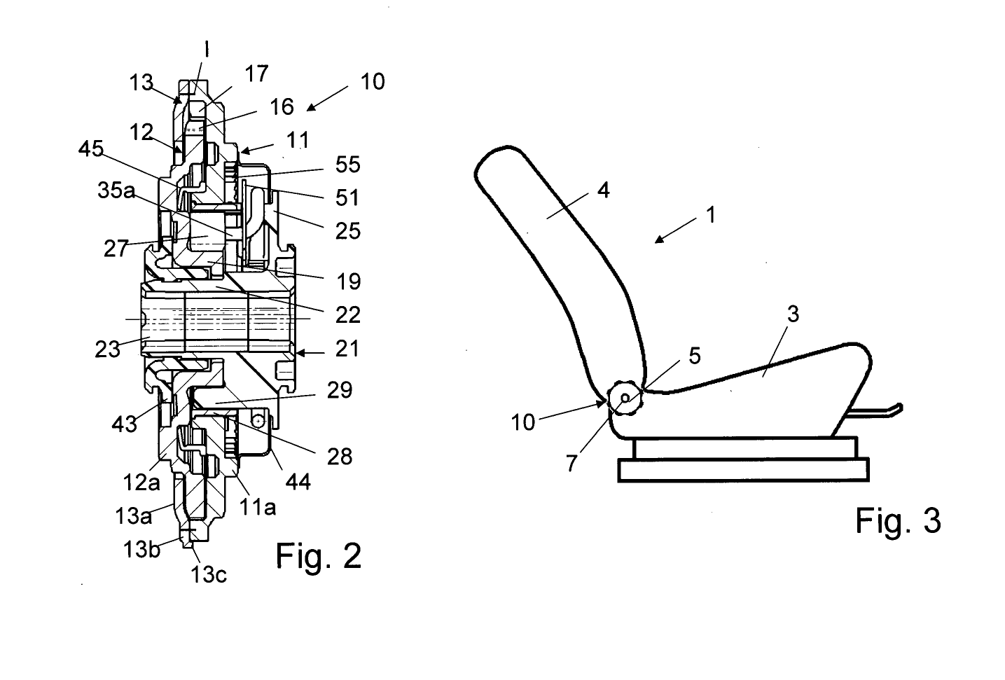

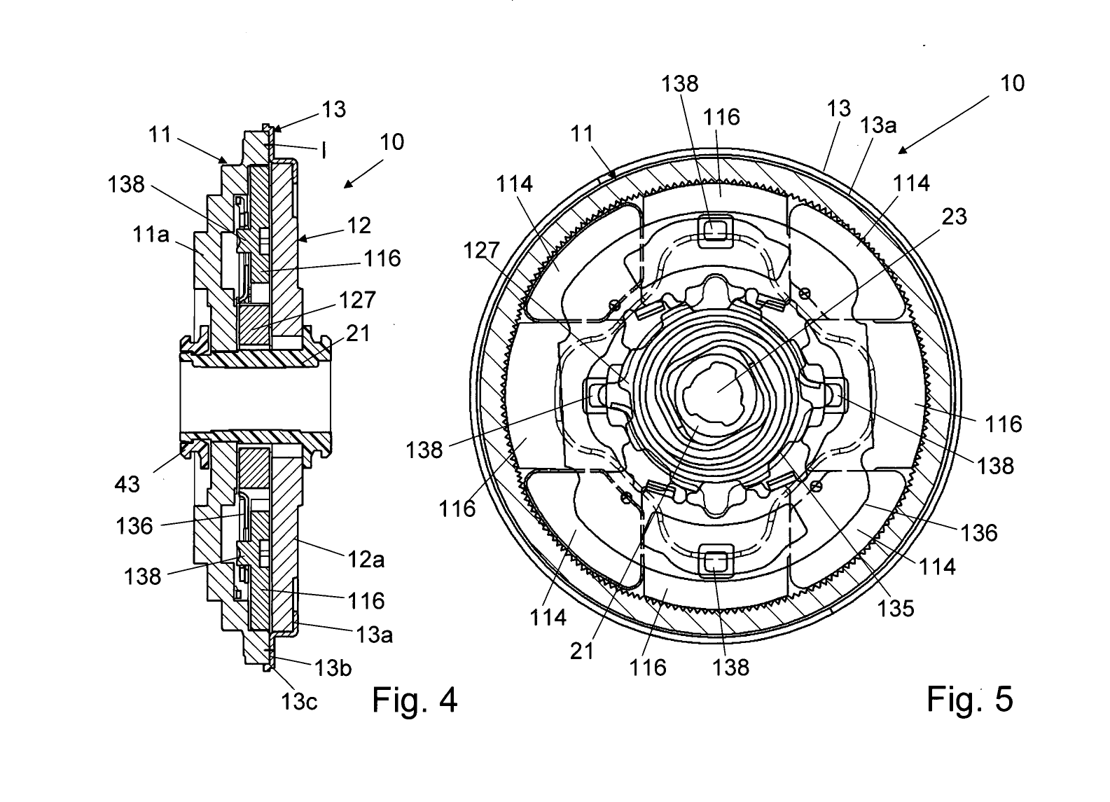

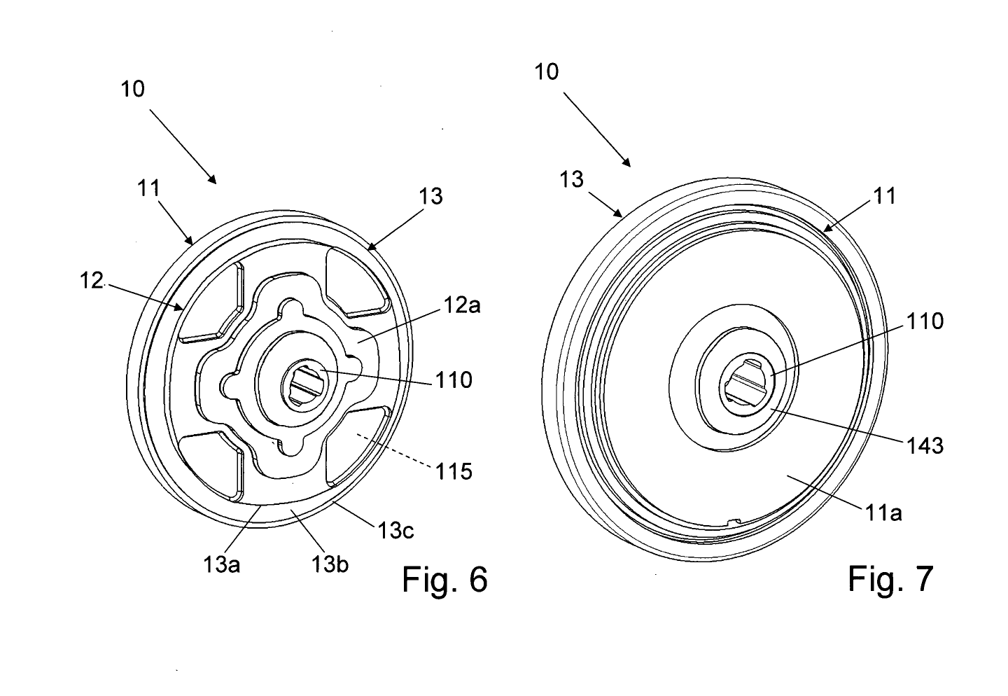

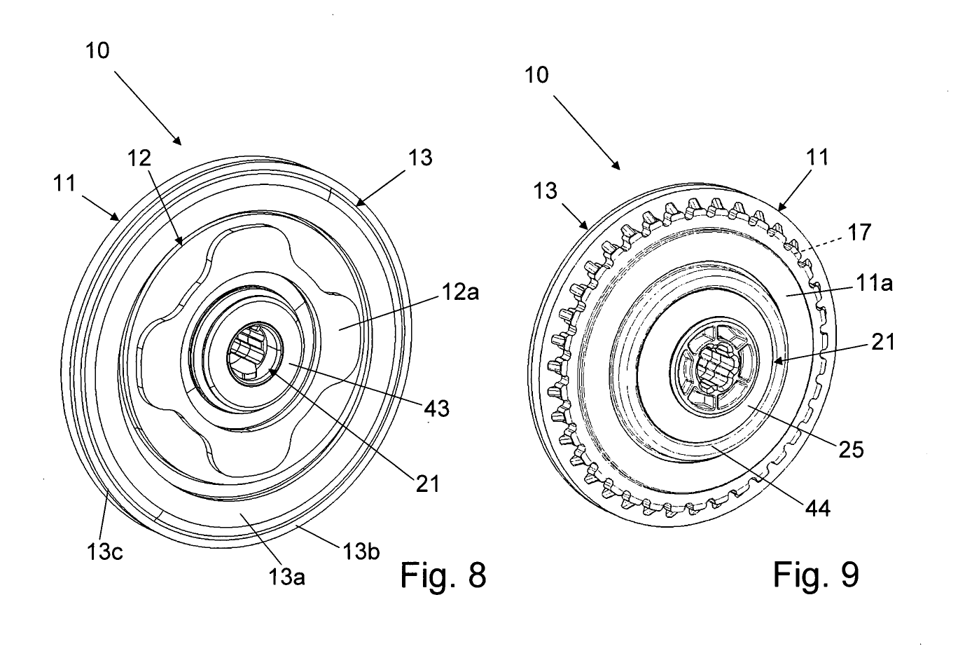

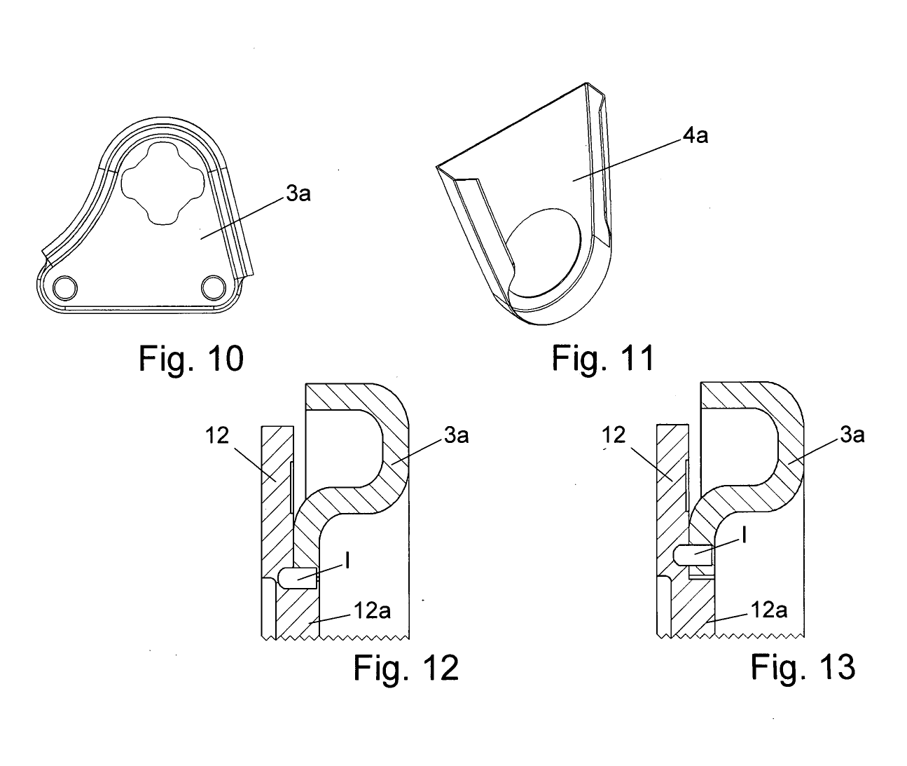

### DESCRIPTION OF THE PREFERRED EMBODIMENTS

Referring to the drawings in particular, a vehicle seat 1 for a motor vehicle has a seat part 3 and a backrest 4, the inclination of which is adjustable relative to the seat part 3. In order to adjust the inclination of the backrest 4, a drive shaft 7, which is arranged horizontally in the transition region between the seat part 3 and the backrest 4, is rotated manually, for example, by means of a hand wheel 5, or in a motor-driven manner, for example by means of an electrical motor. On both sides of the vehicle seat 1, the drive shaft 7 engages in a fitting 10 so that it is rotationally secure. The drive shaft 7 defines the adopted directional data of a cylinder coordinate system.

The fitting 10 has a first fitting part 11 and a second fitting part 12 which are rotatable relative to one another. Each of the two fitting parts 11 and 12 can be approximately inscribed in a circular disk shape. The two fitting parts 11 and 12 are preferably composed of metal, in particular steel which, at least in some areas, can be hardened. In order to absorb the axially acting forces, i.e. in order to hold the fitting parts 11 and 12 axially together, an enclosing ring 13 is provided. The enclosing ring 13 is preferably composed of metal, in particular of steel, which is preferably unhardened. The enclosing ring 13 has a substantially flat ring shape, in the present case with a (radially) inner ring section 13a, a (radially) outer ring section 13b, at least one centering section 13c, and, if appropriate, with connecting sections between them.

The enclosing ring 13 is fixedly connected with one of the two fitting parts 11 and 12, in the present case in the outer ring section 13b with the first fitting part 11. By means of the inner ring section 13a, which is arranged in a plane which is perpendicular to the axial direction, the enclosing ring 13 engages over the second fitting part 12 radially outward (i.e. in its radially outer end section), if appropriate by the interposition of a sliding ring, without impeding the relative rotation of the two fitting parts 11 and 12. Moreover, the inner surfaces of the two fitting parts 11 and 12 which face one another are protected from the intrusion of foreign material and from impurities and damage.

The outer ring section 13b can be arranged in a plane which is slightly offset axially with respect to the inner ring section 13a (for example by the material thickness of the sliding ring), or be bent in profile, at a certain angle to the inner ring section 13a. It is also possible, however, that the outer ring section 13b and the inner ring section 13a flatly (i.e. without step and/or bend and thus unremarkably) merge into one another, i.e. that they are defined merely by their respective neighborhood to the different fitting parts 11 and 12. By means of the outer ring section 13b, the enclosing ring 13 bears—in a preferably planar manner—against the first fitting part 11 at its inner face, more precisely at its inner end face in a radially outer end section, and is fixed to the first fitting part 11 there.

The enclosing ring 13 and the fitting part 11 or 12 which is tightly connected with it consequently enclose the other one of the two fitting parts 11 and 12 which is movable relative to them. From a structural point of view, the two fitting parts 11 and 12 together (with the enclosing ring 13) consequently form a disk-shaped unit.

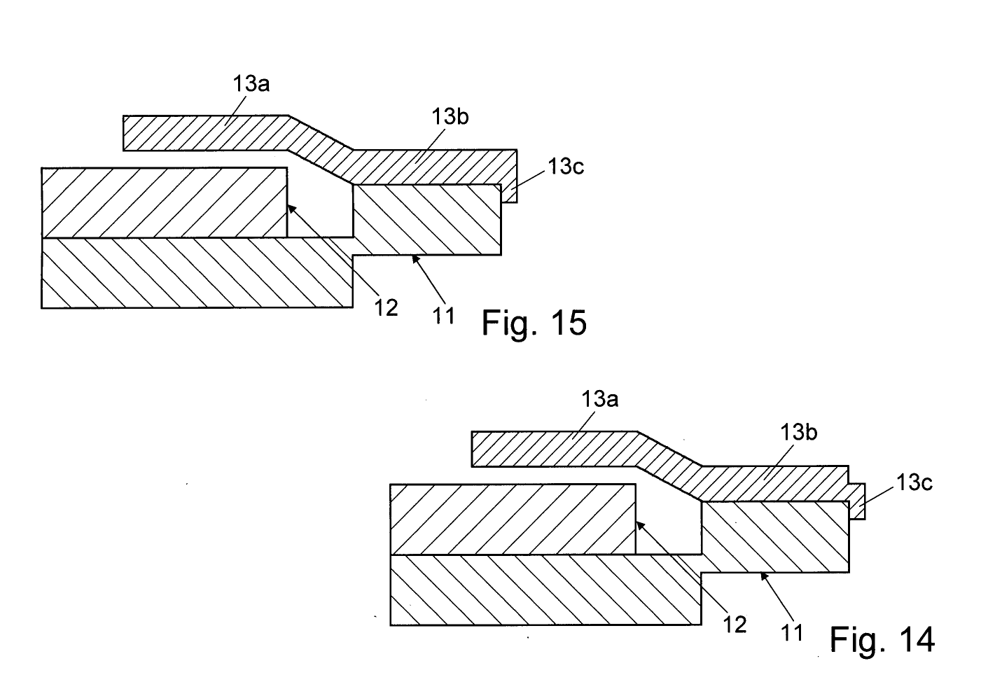

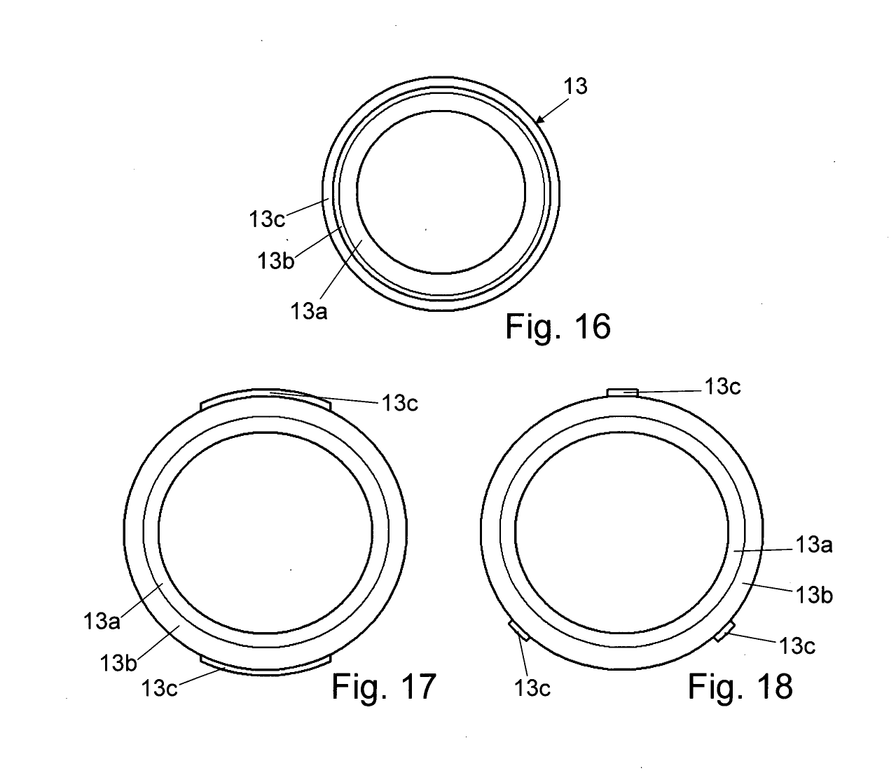

With respect to the outer ring section 13b, the centering section 13c extends in the axial direction, preferably by a maximum of one material thickness of the enclosing ring 13. The centering section 13c clasps the first fitting part 11 radially outward, i.e. the centering section 13c partly covers the first fitting part 11 on its outer surface, more precisely in the cylindrical region of its outer surface. The centering section 13c can be embossed (i.e. the material at the edge of the outer ring section 13b is shifted forward in the axial direction, for example by half the material thickness of the enclosing ring 13), as shown in FIG. 14. The centering section 13c can be configured also by bending of the edge (i.e. the material at the edge of the outer ring section 13a is bent through 90°), as shown in FIG. 15. In the circumferential direction, the centering section 13c can be completely uninterrupted, as shown in FIG. 16, or be interrupted, for example only in two wider arc pieces (FIG. 17) or three smaller arc pieces (FIG. 18). In all cases, the centering section 13c serves for exactly positioning the enclosing ring 13 before fixing it to the first fitting part 11, namely concentrically to the first fitting part 11. Additionally, the centering section 13c increases solidity of the completely assembled fitting 10. In the variant which is completely uninterrupted in the circumferential direction, the centering section 13c, before positioning at the first fitting part 11 takes place, protects the ring shape of the enclosing ring 13 from deformations by axially acting forces, for example during transport after punching.

The enclosing ring 13 can be fixed to the first fitting part 11 by means of laser welding or by means of another fixing technique known per se. In the case of laser welding, it is, for example, possible to generate an I-seam I at a butt joint (analogue to FIG. 12), for example between the outer ring section 13b and the first fitting part 11, or an I-seam I at a lap joint (analogue to FIG. 13) (“penetration”), and more precisely from an axial direction or from a radial direction. The I-seam I can be configured over the circumference with a plurality of single, interrupted weld-seam sections or with one single, uninterrupted weld seam.

With the mounting of the fitting 10, the first fitting part 11 is, for example, connected tightly to the structure of the backrest 4, i.e. it is fixed with respect to the backrest part. The second fitting part 12 is then connected tightly to the structure of the seat part 3, i.e. it is fixed with respect to the seat part. Those assignments of the fitting parts 11 and 12 are preferred, if the radial spacings of the fixing points between the fitting 10 and a relatively thin backrest metal sheet as backrest side support shall be as large as possible. The assignments of the fitting parts 11 and 12 can, however, also be exchanged, i.e. the first fitting part 11 would then be fixed with respect to the seat part and the second fitting part 12 would be fixed with respect to the backrest. The fitting 10 is located in the force flow between backrest 4 and seat part 3.

For a defined interface of the fitting 10 to the structures of seat part 3 and backrest 4, axially protruding contours are provided at the two fitting parts 11 and 12, which cooperate with a positive fit with corresponding openings in structural parts of seat part 3 and backrest 4, for example in customer-specific adapters (in the present case in an adapter 3a which is fixed with respect to the seat part) or directly in the seat frame side part or in the backrest side support 4a. The so pre-positioned fitting 10 can then be fixed to the corresponding structural part, for example by laser welding or by MAG welding. In the case of laser welding, an I-seam I can be provided as an uninterrupted (or in some spots interrupted) weld seam between the fitting 10 and the structural parts 3a or 4a. The I-seam I can be provided as a butt joint (FIG. 12) between the axially protruding contour and the edge of the opening which receives the contour, or as a lap joint (FIG. 13). In the case of MAG welding, the weld seam is preferably provided only at single, distinguished points along the butt joint. If appropriate, the butt joint partly is expanded with a free space, by the edge of the opening being provided with a step or with a bevel, so that the weld seam can better enter, and better joins also in the radial direction.

In the present case, a circular ring shoulder 11a is configured on the first fitting part 11—on its end face facing away from the second fitting part 12—for example by pressing out material when embossing the first fitting part 11. The ring shoulder 11a engages through a circular opening in the backrest side support 4a with a positive fit, so that the backrest side support 4a gets to bear against the first fitting part 11 in the part of the end face of the first fitting part 11 which is arranged radially outside of the ring shoulder 11a. Along the outer edge of the ring shoulder 11a, a weld seam is then applied. In the case of laser welding, the weld seam can reciprocate the circular course of the outer edge of the ring shoulder 11a.

In the present case, a star shoulder 12a is configured on the second fitting part 12—on its end face facing away from the first fitting part 11. The star shoulder 12a has a multiarm, substantially symmetric star shape (in the present case a four-arm cross). The substantially symmetric star shape can be exactly symmetric or show a deviation, the dimension of which is small compared to the (radial) dimensions of the star shoulder 12a, and by means of which (in addition to the star shape), a positioning aid or an anti-rotation element is created, which forces the form-fit with the structural parts 3a and 4a in exactly one possible orientation.

With the present star shoulder 12a, each arm ends with a convex arc (and a straight piece), and the arms in the present case merge into one another tangentially with a concave arc (and a straight piece). Circular arcs, i.e. having a constant curvature, are preferred, however also other, in particular trigonometric arcs are conceivable. In the present case, further pressed-out material is provided in the center of the star shoulder 12a, for reasons of installation space. The star shoulder 12a engages with a positive fit through an exactly appropriate opening in the adapter 3a which is fixed with respect to the seat part (or in the seat frame), so that the adapter 3a which is fixed with respect to the seat part (or the seat frame) gets to bear against the second fitting part 12 in the section of the end face of the second fitting part 12 which is arranged radially outside the star shoulder 12a. Along the outer edge of the star shoulder 12a, a weld seam is then applied. In the case of laser welding, this weld seam can reciprocate the outer edge of the star shoulder 12a. In the case of MAG welding, a short weld seam is provided, for example, at the end of each arm.

The star shoulder 12a has the advantage that, for its configuration, only part of the material of the second fitting part 12 must be pressed out, and nevertheless relatively big spacings of the fixing points arise. Besides, in case of necessity, (due to the star shape and, if appropriate, by deviating from the exact symmetry), a certain orientation of the second fitting part 12 can be forced. In a modified embodiment, a star shoulder instead of a ring shoulder 11a is provided also on the first fitting part 11.

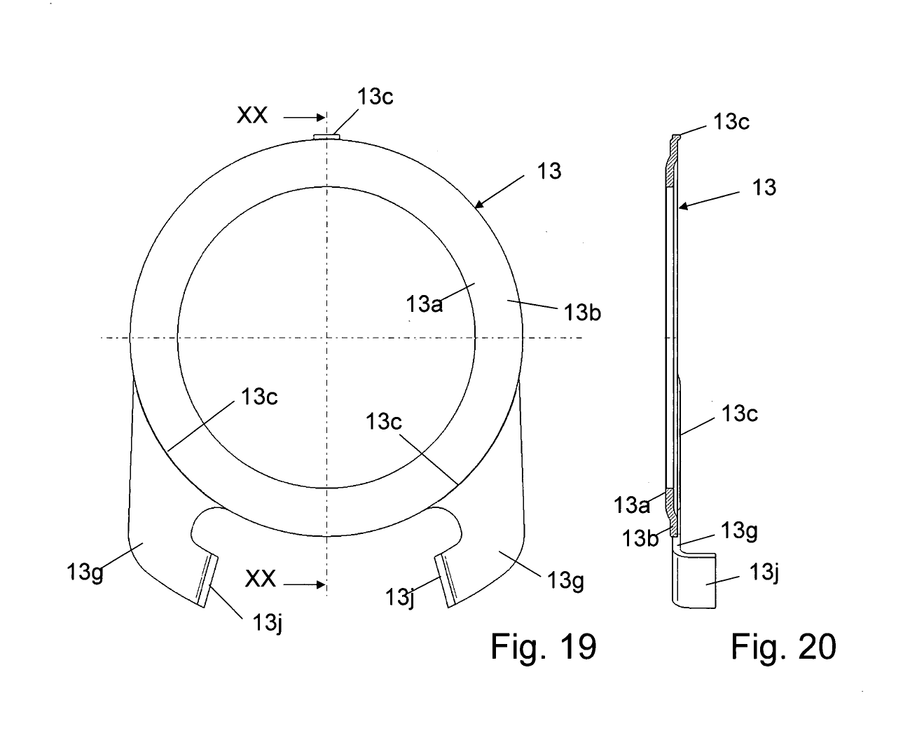

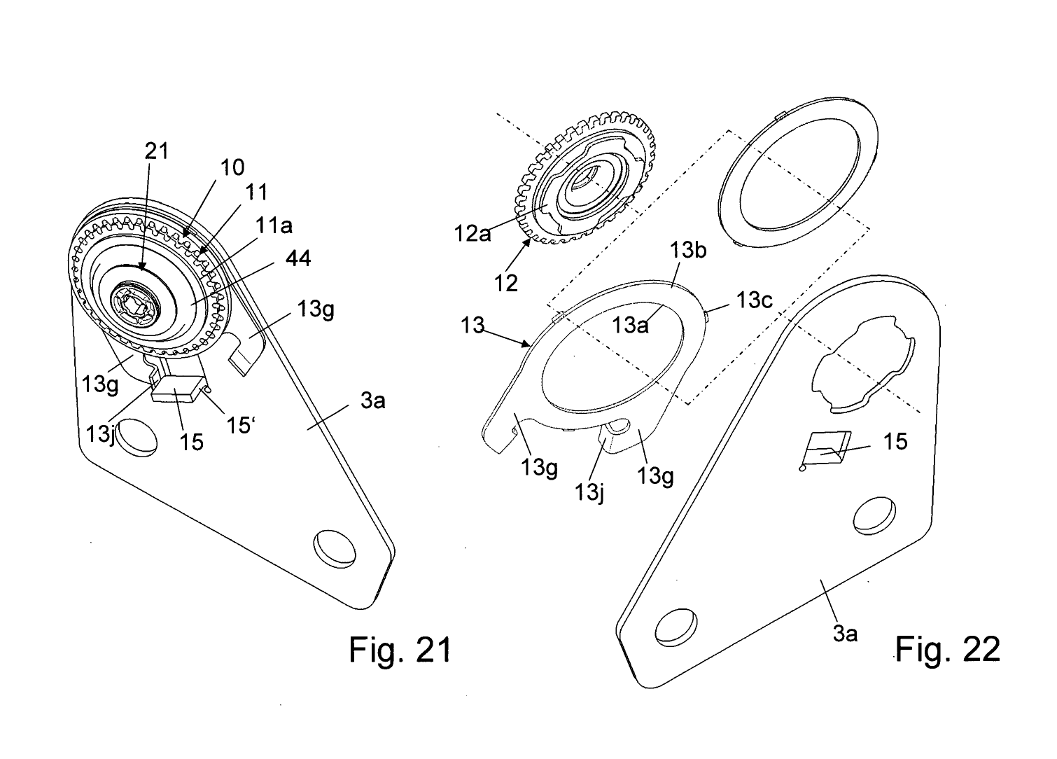

In order to limit the adjusting range forward and/or backward when adjusting the inclination of the backrest 4, i.e. in order to limit the relative rotation of the first fitting part 11 and the second fitting part 12, stops are provided in a modified embodiment (FIG. 19-FIG. 22), of which at least one each is tightly connected with one of the fitting parts 11 or 12—directly or indirectly. In the present case, (exactly) one retaining stop 15 axially protrudes from the adapter 3a which is fixed to the second fitting part 12 and which is fixed with respect to the seat part, such retaining stop being received between (exactly) two limit stops 13g in the circumferential direction. The number and function of the stops can also be exactly reversed. The two limit stops 13g radially protrude outward from the outer ring section 13b of the enclosing ring 13 (which is fixed to the first fitting part 11)—and, if appropriate, additionally in the circumferential direction. The retaining stop 15 preferably is formed on the structure of the seat part 3, in the present case on the adapter 3a which is fixed with respect to the seat part, for example, protrudes from the adapter 3a which is fixed with respect to the seat part or from the seatframe side part (FIG. 21, FIG. 22). The retaining stop 15 can also be configured separately and be fixed to, in particular welded to, the adapter 3 a which is fixed with respect to the seat part (or to any other structural part). The two sides 15′ of the retaining stop 15 which point to the circumferential direction and which, in the present case, are J-shaped due to their protruding, serve as stop faces.

The limit stops 13g are preferably formed on the enclosing ring 13, i.e. configured as a one-part component thereof, but they can be configured also separately and fixed thereto. The centering section 13c and the limit stops 13g can be arranged independently of each other on the outer ring section 13b of the enclosing ring 13 (FIG. 21, FIG. 22), or the two wider arc pieces of the centering section 13c form the transition to the two limit stops 13g, i.e. the limit stops 13g are formed on the centering section 13c and provided with steps relative to the outer ring section 13b (FIG. 19, FIG. 20). The limit stops 13g are configured in a hook-shaped manner, with a section which protrudes radially and/or in the circumferential direction, with a section which is (preferably) perpendicular thereto, which points to the respectively other limit stop 13g, and a section which is perpendicular thereto, i.e. protruding in the axial direction, with a stop face 13j for the retaining stop 15 (and its sides 15′), such stop face pointing in the circumferential direction.

It is conceivable to make available a modular system for the different applications, from which it is possible to choose and take out either an enclosing ring 13 without stops or an enclosing ring 13 with limit stops 13g (FIG. 22) and, correspondingly, an adapter 3a which is fixed with respect to the seat part without or with retaining stop 15.

The external features of the fitting 10 described until now are largely independent of its inner structure, so that they are identical for both exemplary embodiments, apart from detail dimensions. The two exemplary embodiments therefore substantially differ only by features of their inner structure.

In the first exemplary embodiment, the fitting 10 is configured as a gear fitting, in which the first fitting part 11 and the second fitting part 12 are connected by means of a gear unit for displacement and fixing in position, to be more precise, by means of an eccentric epicyclic gear system, which in the present case is self-locking as described, for example, in DE 44 36 101 A1, the relevant disclosure of which is expressly incorporated herein by reference (corresponding U.S. Pat. No. 5,634,689 is incorporated herein by reference).

In order to form the gear unit, an externally toothed wheel 16 is formed on the second fitting part 12, and an internally toothed ring 17 is formed on the first fitting part 11, the toothed wheel and the toothed ring meshing with each other. The diameter of the tip circle of the external toothing of the toothed wheel 16 is smaller by at least the depth of one tooth than the diameter of the root circle of the internal toothing of the toothed ring 17. A corresponding difference in the number of teeth of the toothed wheel 16 and the toothed ring 17 of at least one tooth permits a rolling movement of the toothed ring 17 on the toothed wheel 16. The toothed wheel 16 and the toothed ring 17 are formed preferably by means of one single stamping process which simultaneously punches the fitting parts 11 and 12 from their initial material.

One of the two fitting parts 11 and 12 on the side facing the toothed ring 17, in the present case the second fitting part 12, has a collar 19 concentrically to the toothed wheel 16. The collar 19 can be integrally formed on (i.e. formed in one piece with) said fitting part as a collar formation or be secured thereto in the form of a separate sleeve. A driver 21 is supported rotatably in the collar 19 by means of a hub 22. The driver 21 is preferably composed of plastics material. The hub 22 of the driver 21 is provided centrally with a bore 23 for receiving the drive shaft 7. The profile of the bore 23 is configured to fit the profile of the drive shaft 7, in the present case a splined shaft profile. Adjoining its hub 22, the driver 21 has a covering disk 25 which is formed in one piece with the hub 22 and which has a larger diameter than the hub 22.

Supported on the collar 19—with their curved inner surfaces—are two wedge segments 27 which bear—with their curved outer surfaces—the other of the two fitting parts 11 and 12, in the present case the first fitting part 11. For this purpose, a receptacle of the last-named fitting part is coated with a slide bearing bush 28 which is preferably pressed in to be rotationally fixed, and against which the outer surfaces of the wedge segments 27 bear. The notions “support” and “bear” shall not be limited to a defined direction of the flow of forces by the fitting 10, since this direction depends on the mounting of the fitting 10.

The driver 21 has—spaced radially from the hub 22—a driver segment 29 which engages with clearance between the narrow sides of the wedge segments 27 and which is formed in one piece with the covering disk 25 and the hub 22. The mutually facing broad sides of the wedge segments 27 each receive, with a respective recess defined by projecting sections of material, a respective angled end finger 35a of an omega spring 35. The spring 35 acts upon the wedge segments 27 in the circumferential direction, in particular in order to press them apart, it being possible during operation for the broad sides of the wedge segments 27 to touch and act on each other.

The driver 21 is secured axially on the outside of the fitting part provided with the collar 19 by a securing ring 43 which is preferably clipped on. The securing ring 43 extends in the axial direction along a part of the hub 22, so that the hub 22 does not directly bear against the inside of the collar 19 but, with the interposition of the securing ring 43, is supported in the collar 19 (and consequently the driver 21 is supported on the second fitting part 12). On the outside of the fitting part provided with the slide bearing bush 28 (in the present case of the first fitting part 11), a sealing ring 44 is provided between its radially outermost edge and the covering disk 25, such sealing ring being composed for example of rubber or of soft plastics material and being connected with, in particular clipped to, the covering disk 25. The sealing ring 44 can also be composed of metal and be tightly connected, for example welded, to the first fitting part 11, the covering disk 25 then being movable relative to the sealing ring 44. Within the installation space between the two fitting parts 11 and 12, a separating ring 45, composed for example of plastics material, is optionally provided as internal sealing.

The wedge segments 27 (and the spring 35) define an eccentric which, in the extension of the direction of eccentricity, presses the toothed wheel 16 into the toothed ring 17 at an engagement site. When drive is effected by means of the rotating drive shaft 7 which rotates (several times), a torque is first of all transmitted onto the driver 21 and then, by means of the driver segment 29, onto the eccentric which is so defined and which slides along the slide bearing bush 28, shifting the direction of eccentricity and thus shifting the site of engagement of the toothed wheel 16 in the toothed ring 17, this presenting itself as a wobbling rolling movement, i.e. as a relative rotation with a superimposed wobbling movement. As a result, the inclination of the backrest 4 is continuously adjustable between several use positions.

To improve the dynamic operating characteristics, a retaining spring 51 as has been disclosed, for example in DE 195 48 809 C1, the disclosure of which is expressly incorporated herein (corresponding U.S. Pat. No. 5,871,414 is incorporated herein by reference), is still provided preferably as locking element. The retaining spring 51 in the present case cooperates with a toothing 55, which is configured as a further toothed ring at the first fitting part 11. The retaining spring 51—which is preferably supported on an axial projection of the slide bearing bush 28—each time locks the wedge segments 27 in the non-driven state (by the retaining spring 51 locking the spring 35 by bearing against the end fingers 35a) and is released by the driven driver 21.

Due to the present mounting of the fitting 10, the eccentric (i.e. primarily the wedge segments 27) is supported by the second fitting part 12, while, on its part, it supports the first fitting part 11. The relationships could, however, be exactly reversed, i.e. the first fitting part 11 supports the eccentric which, on its part, supports the second fitting part 12. Besides, the collar 19 can be provided on the first fitting part 11, i.e. concentrically to the toothed ring 17, and the slide bearing bush 28 can be provided on the second fitting part 12, i.e. concentrically to the toothed wheel 16. The sequence in the arrangement from the driver 21 to the securing ring 43 will be reversed correspondingly. The last-named arrangement has the advantage that the engagement of the teeth between toothed wheel 16 and toothed ring 17 on the one hand, and supporting of the eccentric on the other hand take place in the same plane. The arrangement described in the first exemplary embodiment has the advantage that a larger surface for fixing to the structure of the seat part 3 is available on the “smaller” second fitting part 12, i.e. that the star shoulder 12 a can be accommodated in particular. Basically both arrangements are equivalent, however.

In the second exemplary embodiment, in which identical components and components having an identical effect are designated with identical reference numerals, the fitting 10 is configured as a detent fitting, in which the first fitting part 11 and the second fitting part 12 can be locked with each other, as is described , for example, in DE 10 2006 015 560 B3, the relevant disclosure of which is expressly incorporated herein (corresponding U.S. Pat. No. 7,677,667 is incorporated herein by reference).

The second fitting part 12 has—in the present case four—guide segments 114 which, with their straight guide faces, respectively guide a latch 116 pairwise laterally in the radial direction. The—in the present case four—latches 116 are displaced with respect to each other—in the present case by 90° each—and arranged in an installation space which is defined between the two fitting parts 11 and 12. The latches 116 are provided with a toothing at their radially outer end, said toothing engaging (fitting) with a toothed ring 17 of the first fitting part 11 which is configured as a hollow wheel. If the toothed ring 17 and the latches 116 interact with each other, the fitting 10 is locked. The guide segments 114 bear against the toothed ring 17 of the first fitting part 11 with one respective bent bearing surface, the two fitting parts 11 and 12 supporting each other.

A driver 21, for example composed of plastic material, is arranged in a rotationally rigid manner—or at least mechanically connected—in the center of the fitting 10, said driver being arranged on the drive shaft 7 by means of a central bore 23 and being supported rotatably on at least one of the two fitting parts 11 and 12, in the present case on the first fitting part 11, more precisely in a central opening of the latter. An eccentric 127 is arranged on the driver 21 in a rotationally rigid manner or at least mechanically connected to it, said eccentric being arranged in an installation space which is defined between the fitting parts 11 and 12. A spring arrangement 135, for example one or two spiral springs which include each other, is arranged in a central cutout of one of the two fitting parts 11 and 12, in the present case of the second fitting part 12 and, in the present case, supported outside. The spring arrangement 135 acts upon the eccentric 127, in the present case, by being arranged on the inside of the driver 21 in a rotationally rigid manner. Such a spring arrangement 135 is described, for example in DE 10 2005 046 807 B3 the relevant disclosure of which is expressly incorporated herein (corresponding U.S. Pat. No. 7,571,963 is incorporated herein by reference). The eccentric which is under the action of the spring arrangement 135 acts upon the radially movable latches 116 and impinges on them, so that they are pressed radially outward, in order to engage in the toothed ring 17, thus locking the fitting 10.

A control disc 136 is arranged in the installation space axially between the latches 116 and the first fitting part 11 and is arranged—in the present case in a rotationally rigid manner —on the eccentric 127. The control disc 136 has—in the present case four—control curves which interact with respectively one lug 138 of each latch 116. The lugs 138 axially protrude from the assigned latches 116. The driver is secured axially by a retaining ring 43 which, during mounting of the fitting 10 is fixed, preferably clipped on, to the driver. The driver 21 and the retaining ring 43 each have one flange which respectively bears against the outer side of one of the two fitting parts 11 or 12 and which acts as a sealing. In the case of a rotation (by few degrees) of the driver 21—and of the eccentric 127 which is driven by it and the control disc 136—opposed to the force of the spring arrangement 135, the control disc 136 tears the latches 116 radially inward, i.e. out of the toothed ring 17, thus unlocking the fitting 10, and the two fitting parts 11 and 12 being pivotable relative to each other, about the drive shaft 7. The inclination of the backrest 4 is thus adjustable between several positions of use for seating use.

Due to the present mounting of the fitting 10, the first fitting part 11 is supported by means of its toothed ring 17 on the guide segments 114 of the second fitting part 12. The relationships could, however, be exactly reversed, i.e. the second fitting part 12 is supported by means of its guide segments 114 on the first fitting part 11, on its toothed ring 17. The arrangement described in the second exemplary embodiment has the advantage that the star shoulder 12a with its four arms can engage exactly between the four guide segments 114, optimizing the guide length for the four latches 116. Besides, in the center of the star shoulder 12a, the installation space required for the spring arrangement 135 can be created by means of a further shoulder. Basically, both arrangements are equivalent, however.

While specific embodiments of the invention have been shown and described in detail to illustrate the application of the principles of the invention, it will be understood that the invention may be embodied otherwise without departing from such principles.

1. A fitting for a vehicle seat comprising:
a first fitting part;
a second fitting part the first fitting part being rotatable relative to the second fitting part; and
an enclosing ring, the first fitting part and the second fitting part being axially held together by the enclosing ring, the enclosing ring being provided with an inner ring section, by means of which the enclosing ring engages over the second fitting part radially outward, with an outer ring section, by means of which the enclosing ring is fixed to the first fitting part, at a front end, in an outer end section, and with a centering section which extends axially with respect to the outer ring section and which engages over the first fitting part radially outward and partly covers the outer surface thereof.

2. The fitting according to claim 1, wherein the centering section extends axially with respect to the outer ring section, by a maximum of one material thickness of the enclosing ring.

3. The fitting according to claim 1, wherein the centering section is embossed or configured by bending of an edge.

4. The fitting according to claim 1, wherein the centering section extends in the circumferential direction completely uninterrupted.

5. The fitting according to claim 1, wherein the centering section is configured in the circumferential direction in at least two arc pieces.

6. The fitting according to claim 1, wherein the outer ring section is arranged in a plane which is axially offset from the inner ring section towards the first fitting part.

7. The fitting according to claim 1, wherein a toothed ring is configured on one of the fitting parts and a toothed wheel is configured on the other one of the fitting parts, such toothed ring and toothed wheel meshing with each other, whereby the two fitting parts are in geared connection with each other, and a rotatably supported rotating eccentric which is driven by a driver is provided for driving a relative rolling movement of toothed wheel and toothed ring.

8. The fitting according to claim 7, wherein the toothed wheel is configured at the radially outer edge of the second fitting part.

9. The fitting according to claim 1, wherein a toothed ring is configured on one of the two fitting parts and guide segments for supporting the toothed ring and for guiding latches are configured on the other one of the fitting parts and a spring-loaded, rotatably mounted eccentric acts upon the latches which are movable in the radial direction, and which interact with the toothed ring, in order to lock the fitting.

10. The fitting according to claim 9, wherein the guide segments are configured on the radially outer edge of the second fitting part.

11. A vehicle seat comprising:
a seat part;
a backrest; and
a fitting connected to said seat part and said backrest, the fitting comprising:
a first fitting part;
a second fitting part the first fitting part being rotatable relative to the second fitting part; and
an enclosing ring, the first fitting part and the second fitting part being axially held together by the enclosing ring, the enclosing ring comprising an inner ring section, by means of which the enclosing ring engages over the second fitting part radially outward, an outer ring section, by means of which the enclosing ring is fixed to the first fitting part, at a front end, in an outer end section, and a centering section which extends axially with respect to the outer ring section and which engages over the first fitting part radially outward and partly covers the outer surface thereof.

12. The vehicle seat according to claim 11, wherein the centering section extends axially with respect to the outer ring section, by a maximum of one material thickness of the enclosing ring.

13. The vehicle seat according to claim 11, wherein the centering section is embossed or configured by bending of an edge.

14. The vehicle seat according to claim 11, wherein the centering section extends in the circumferential direction completely uninterrupted.

15. The vehicle seat according to claim 11, wherein the centering section is configured in the circumferential direction in at least two arc pieces.

16. The vehicle seat according to claim 11, wherein the outer ring section is arranged in a plane which is axially offset from the inner ring section towards the first fitting part.

17. The vehicle seat according to claim 11, wherein:
the fitting further comprises an eccentric and a driver; and
one of the fitting parts comprises a toothed ring and the other of the fitting parts comprises a toothed wheel, the toothed ring and the toothed wheel meshing with each other, whereby the two fitting parts are in geared connection with each other, and the eccentric is rotatably supported and driven by the driver for driving a relative rolling movement of toothed wheel and toothed ring.

18. The vehicle seat according to claim 17, wherein the toothed wheel is configured at the radially outer edge of the second fitting part.

19. The vehicle seat according to claim 11, wherein;
the fitting further comprises a spring-loaded, rotatably mounted eccentric and latches which are movable in the radial direction; and
one of the fitting parts comprises a toothed ring and the other of the fitting parts comprises guide segments for supporting the toothed ring and for guiding the latches, and the spring-loaded, rotatably mounted eccentric acts upon the latches which are movable in the radial direction, and which interact with the toothed ring, in order to lock the fitting.

20. The vehicle seat according to claim 19, wherein the guide segments are configured on the radially outer edge of the second fitting part.
